(19) United States
(12) Patent Application Publication
(10) Pub. No.: US 2011/0080083 A1
(43) Pub. Date: Apr. 7, 2011

(54) HOUSEHOLD APPLIANCE

(75) Inventors: Klaus Engel, Sinsheim (DE); Christine Linke, Gundelfingen (DE); Alexander Rupp, Prov Jiangsu (CN)

(73) Assignee: BSH BOSCH UND SIEMENS HAUSGERATE GMBH, Munich (DE)

(21) Appl. No.: 12/995,201

(22) PCT Filed: May 27, 2009
(86) PCT No.: PCT/EP09/56447

§ 371 Date: Nov. 30, 2010

(30) Foreign Application Priority Data
Jun. 2, 2008 (DE) 10 2008 026 383.4

(51) Int. Cl. F25D 23/02; A47B 96/00; E05F 5/02; E05F 3/16

(52) U.S. Cl. 312/405; 312/326; 49/358; 312/327

(57) ABSTRACT

A household appliance that includes a housing having an opening; a door rotatable about a first rotation axis to selectively open or close the opening; and a braking system to damp a rotational movement of the door when the door is opened or closed. The braking system includes a damper and a transmission unit that is coupled between the door and the damper to be driven by the door and for transmitting a movement of the door to the damper.

### FIELD OF THE INVENTION

The present invention relates to a household appliance, in particular a refrigerator, more particularly, to a household appliance including a housing having an opening and a door rotatable about a rotation axis for selectively opening or closing the opening.

### BACKGROUND OF THE INVENTION

Arrangements of the above type are known from the prior art. A damper is normally used to prevent sharp movement of the door, in particular, when the door is opened and closed with rotation movement about a horizontal axis where gravity of the door could make the door fall down sharply.

In a side-by-side refrigerator like that as disclosed in US 2004/0178710 A1, a mini-door attached to a main door for a refrigerating compartment is provided with a damper for damping the rotation movement of the mini-door. The damper includes a case filled with oil and a rotation shaft rotatably mounted in the case. The damper is arranged to the opposite sides of the mini-door and the rotation shaft of the damper is connected to a hinge shaft of the mini-door which projects from a side surface of the mini-door, whereby the rotation movement of the mini-door when it is opened is supposed to be damped by a friction force or a hydraulic force generated between the rotation shaft and the oil.

To mount the damper to the refrigerator, additional space located between a side edge of the opening and a corresponding outer wall of the housing in the longitudinal direction, should be reserved for mounting the damper when the damper is mounted at the same lever as the hinge shaft in the prior art. When the damper has a relatively large length in the transversal direction, such required space limits the dimension of the opening and the mini-door. This drawback is more obvious when a larger damper is employed to damp a mini-door having larger weight. Another possible way to increase the damping force would be use of dampers with more-viscous fluid. These possible solutions would lead to another problem: for doors with different characteristics, the manufacturers have to use dampers with different sizes and/or types.

In addition, it is known in the prior art to use a push-push type door-opening unit to lock the mini-door in a close position and to release the mini-door from the lock state and generate an opening force to push the mini-door away from the close position such that the mini-door can start to rotate before the gravity of the mini-door makes it rotate downwardly. Such door-opening unit is arranged in association with an upper portion of the mini-door. For mini-doors with different characteristics, it is found that such door-opening unit sometimes is not reliable enough to pre-open the mini-doors.

### SUMMARY OF THE INVENTION

It is accordingly an object of the invention to overcome at least one of the problems as set forth above, and to provide a household appliance, in particular a refrigerator, where sharp rotation movements of a door can be reliably prevented and meanwhile the flexibility of choosing and arranging a damper can be significantly improved.

The object is achieved by providing a household appliance in particular, a refrigerator, comprising a housing having an opening, a door rotatable about a first rotation axis for selectively opening or closing the opening, and a braking system for damping the rotation movement of the door when the door is opened or closed, wherein the braking system comprising a damper, characterized in that the braking system comprises a transmission unit coupled between the door and the damper for being driven by the door and transmitting the movement of the door to the damper.

In such a way, the downward rotation movement of the door can be damped by the damper by transmitting the damping force therefrom to the door via the transmission unit. According to the present invention, it is believed that it is more flexible to choose characteristics (such as structure, dimension) of the damper based on the damping force required by the door, thereby the movement of the door can be damped more suitably and reliably. Further, with the transmission unit, location of the damper can be chose depending on requirements, since options of the location of the damper may not be limited to the first rotation axis according to the present invention.

Other features which are apart or in combination with other features considered as characteristic for the invention are set forth in the depended claims.

According to a preferred embodiment of the invention, the door comprises a hinge shaft which defines the first rotation axis, and wherein the transmission unit is coupled to the hinge shaft, which is particularly advantageous for mounting the transmission unit and the transmission unit may have a relatively compact size. It is also advantageous in aesthetics aspects.

According to a preferred embodiment of the invention, the transmission unit has a transmission ratio less than 1 from the door to the damper, thereby the damper can rotate at relatively lower angular velocity, which is particular good for sealing if the damper is filled with fluid. Further, the input end directly driven by the door can have smaller size (such as diameter of a rotating component), than that of the output end coupled to the damper, which is advantageous for damping the movement of the door because the friction force generated by the damper can be amplified from the output end (damper end) to the input end (door end).

In accordance with a preferred embodiment, the damper comprises a rotatable element configured to rotate about a second rotation axis distanced from the first rotation axis, thereby arrangement of the damper is much more flexible and the choices on dimensions of the damper are accordingly increased.

Although the second rotation axis may be intersected to the first rotation axis, according to the particularly preferred embodiment, the second rotation axis is parallel to the first rotation axis, which is particularly easier to construct the transmission unit and the movement can transmitted reliably.

Although it is possible to use another kind of damper, according to a particularly preferred embodiment of the invention, the damper comprises a chamber with viscous fluid in contact with the rotatable element.

According to a particularly preferred embodiment of the invention, the damper is arranged in the housing along a transversal edge of the opening.

Although it is possible that the damper is arranged in other places, according to a preferred embodiment of the invention, the damper is arranged lower the door, such that the damper can be closer to the first rotation axis on one hand, and on the other hand, the it is possible to have a relatively large damper without limiting the size of the door and the opening on the housing.

In order to obtain a stable transmission with long time, the transmission unit may comprise at least two gears. Advantageously, the transmission unit may comprise a first gear rotatable about the first rotation axis and a second gear coupled to the damper.

According to a particularly preferred embodiment of the invention, the second gear has a diameter larger than the diameter of the first gear, thereby the damper can be kept at a lower speed which is particularly advantageous for dampers with viscous fluid therein.

According to a preferred embodiment of the invention, the transmission unit comprises a base to which said gears are attached, whereby the position and distance between the gears can be easily and precisely controlled.

Advantageously, the transmission unit further comprises at least one further gear coupled between the first gear and the second gear, whereby the distance between the first and the second gears can be relatively large while it is possible to use gears with relatively small size. A compact transmission unit can accordingly be expected.

According to a particularly preferred embodiment, the rotation axis of the further gear is distanced from a plane defined by the rotation axes of the first and second gears. In such a way, the transmission unit may have a more compact size because of such arrangement of the gears.

In accordance with an alternative embodiment, the transmission unit may comprise a belt transmission device and/or a chain transmission device.

According to a preferred embodiment of the invention, the household appliance may comprise at least one opening unit for generating an opening force to the door at least when the door is closed, wherein the opening unit is coupled to the braking system. In such a way, it is possible that the door can automatically rotate downwardly after it has been released from the housing. Meanwhile, with such arrangement, it is possible that the opening unit can be arranged without being exposed to users when the braking system is not exposed to the users.

Advantageously, the opening unit comprises a spring. According to a particularly preferred embodiment, the spring is a torsion spring.

According to a preferred embodiment of the invention, the housing comprises a storage compartment and a main door for selectively opening or closing the storage compartment, and wherein the opening is formed through the main door and the door is attached to the main door.

According to a preferred embodiment of the invention, at least part of the transmission unit is mounted in the main door, whereby it is possible that more space can be provided to arrange the transmission unit.

According to a preferred embodiment of the invention, wherein the main door has a side portion which is positioned between a longitudinal edge of the opening and a corresponding side wall of the main door, and at least part of the transmission unit is located in the side portion.

According to a preferred embodiment of the invention, the main door comprises a front wall and a rear wall faced to the storage compartment when the main door is closed, wherein the damper and the transmission unit are disposed between the front wall and the rear wall.

To prevent the transmission unit and/or the damper being polluted by foreign particles or other components of the household appliances, for instance thermal insulation material between the front wall and the rear wall, it is preferred that a casing enclosing the transmission unit and/or the damper is provided.

According to a preferred embodiment of the invention, the casing comprises a body defining a receiving chamber receiving the transmission unit, and a lid attached to the body to close the chamber, which facilitates assembly of the case and the transmission unit and/or the damper because the case can be closed after the transmission unit and/or the damper has been located inside the receiving chamber.

According to a particularly preferred embodiment, the casing is attached to a frame mounted to the housing around the opening. In a particularly preferred embodiment, at least part of the casing is made as an integral part of the frame.

According to a particularly preferred embodiment, the frame has a first side faced to the opening and the second side opposite to the first side, wherein the casing is attached to the frame at the second side. In such a way, it is possible that the casing is not visible by users.

The present invention is particularly suitable when the first rotation axis is horizontal, in which case the gravity of the door causes sharp downward rotation movement of the door.

The present invention is particularly suitable for refrigerators, for instance a side by side refrigerator with a home-bar/mini door in a main door such as a refrigerating compartment door.

The construction of the invention, however, together with additional objects and advantages thereof will be best understood from the following description of specific embodiments when read in connection with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic front view of a refrigerator according to a preferred embodiment of the present invention.

FIG. 2 is a schematic perspective view of a refrigerating compartment door according to a preferred embodiment of the present invention.

FIG. 3 is an enlarged sectional view of the section I-I in FIG. 1 according to a preferred embodiment of the present invention.

FIG. 4 is a schematic perspective view showing a door coupled to a braking system according to a preferred embodiment of the present invention.

FIG. 5 is a schematic exploded view of a transmission unit according to a preferred embodiment of the present invention.

FIG. 6 is a side view of a transmission unit with a cover member being removed according to a preferred embodiment of the present invention.

### DETAILED DESCRIPTION OF THE EMBODIMENTS

In the following detailed description of the preferred embodiments, identical or similar features have the same reference signs.

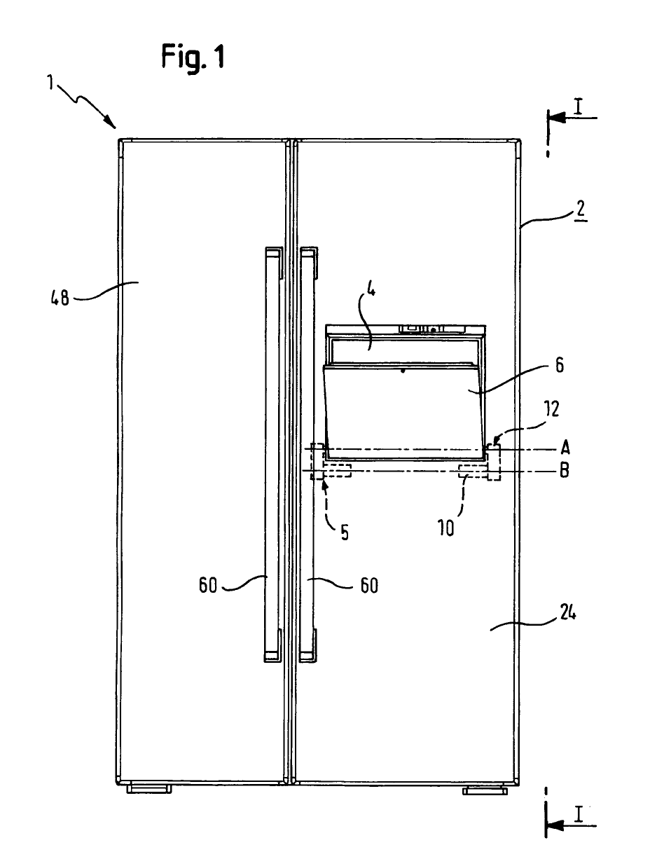

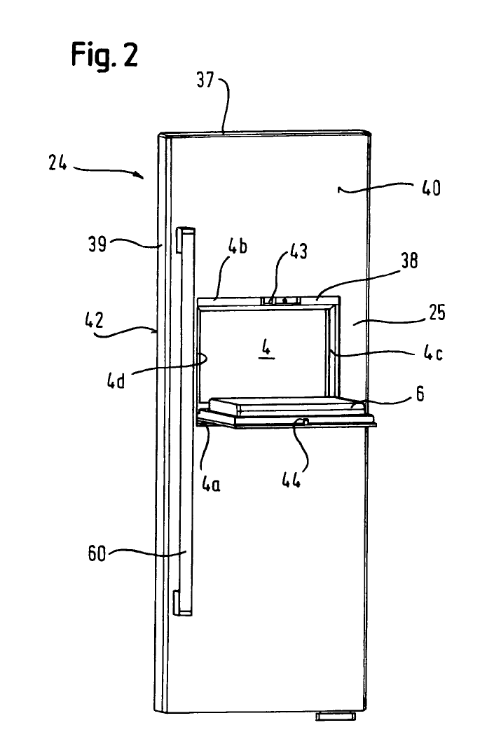

Referring now to the figures of the drawing in detail and first, particularly, to FIGS. 1, and 2 thereof. The refrigerator 1 includes a housing 2 defining a refrigerating storage compartment (not shown) which has a frontal opening selectively closed and opened by a refrigerating compartment door 24. The refrigerating compartment door 24 is rotatable about a longitudinal axis.

In this embodiment, a freezer storage compartment (not shown) is arranged side by side to the refrigerating storage compartment and is selectively closed or opened by a freezer compartment door 48. The refrigerating and freezer compartment doors 24, 48 define the front surface of the refrigerator 1.

It should be understood that though the preferred embodiment as illustrated is a side by side refrigerator, the present invention should not be limited thereto.

The freezer compartment door 48 and the refrigerating compartment door 24 each has a handle 60 which facilitates users to open or close the freezer compartment door 48 and the refrigerating compartment door 24.

The refrigerating compartment door 24 comprises a front wall 40 defines a front surface of the refrigerating compartment door 24, a rear wall 42 which is faced to the refrigerating storage compartment when the refrigerator compartment door 24 is in the close position. The rear wall 42 is distanced from the front wall 40 and an thermal insulation space (not shown) is formed therebetween to receive thermal insulation material. The thermal insulation space is closed by upper and lower walls 37, and left and right side walls 39 of the refrigerating compartment door 24.

When the refrigerating compartment door 24 is opened, ambient air enters into the refrigerating storage compartment. The ambient air usually has a temperature higher than a preset temperature set by a user or manufacturer. In some area, the ambient air contains high humidity. Accordingly, a cooling circuit of the refrigerator 1 has to work to reduce the temperature and/or the humidity within the compartment, which increases the energy consumption of the refrigerator 1. To reduce the energy consumption caused by opening the refrigerating compartment door 24, an opening 4 is formed through the refrigerating compartment door 24 and is normally closed by a door 6.

Through this opening 4, the user can access, without opening the refrigerating compartment door 24, to the refrigerating storage compartment and/or a storage space on the rear side of the refrigerating compartment door 24, thereby reducing heat exchange between the refrigerating storage compartment 26 and the ambient.

The opening 4 has a rectangular shape and comprises a lower edge 4a, an upper edge 4b and side edges 4c, 4d. The lower and upper edges 4a, 4b extend transversely in horizontal direction, and the side edges 4c, 4d extend in longitudinal direction.

The side edges 4c, 4d are distanced from a respective side wall 39 of the main door 24. The main door 24 has side portions 25 each of which is located between a respective side edge 4c, 4d of the opening 4 and a respective side wall 39 of the main door 24.

The refrigerating compartment door 24 has a frame 38 mounted along the opening 4. The frame 38 has a first side which is exposed to the opening 4 and a second side which is faced to the space and therefore exposed the thermal insulation material in the space.

The opening 4 is selectively closed or opened by the door 6. For refrigerators, the refrigerating compartment door 24 with a door 6 thereon can be also called as a main door, and the door 6 can be called as a mini-door or a home-bar door.

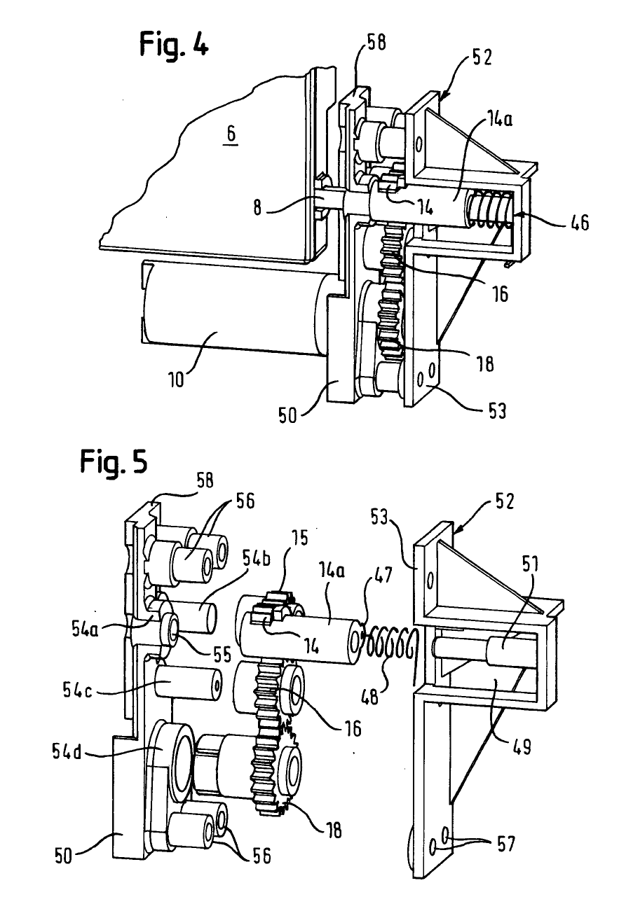

Referring to FIGS. 1 to 5, the door 6 is attached to the refrigerating compartment door 24 by a hinge shaft 8. The hinge shaft 8 extends in a horizontal direction and has an end received in a bottom portion of the door 6 and another end extending beyond the door 6.

The hinge shaft 8 defines a first rotation axis A. The first rotation axis A is parallel to a horizontal plane and is adjacent to the lower edge 4a of the opening 4. The door 6 is rotatable about the first rotation axis A between an open position in which the door 6 is opened and thus the opening 4 is accessible, and a close position in which the opening 4 is closed by the door 6. Preferably, the door 6 is substantially parallel to the horizontal plane when it is in the open position.

The refrigerator 1 preferably has a first door-opening unit 43 to lock the door 6 in the close position and to release the door 6 from the locked state and generate a first opening force to push the door 6 away from the close position.

The first door-opening unit 43 may have typical push-push structure. By pushing the door 6, the door 6 is locked in the close position by a latch member 44 of the first door-opening unit 43 such that the downward movement of the door 6 is prevented, and by pushing again the door 6, the door 6 is released from the locked state and the first opening force is generated, for instance by a spring of the first door-opening unit 43, to push the door 6 away from the close position.

The first door-opening unit 43 is preferably arranged in association with an upper portion of the door 6, such that the door 6 can be locked easily and the door 6 can start to rotate with a relatively small opening force.

When the door 6 rotates to said predetermined angle after which the gravity of the door 6 is able to drive the door 6 to rotate downwardly, the door 6 would rotate sharply because of the gravity without any damping means.

In order to avoid sharp fall of the door 6, the refrigerator 1 comprises a braking system 5 to damp the downward rotation movement of the door 6. The damping force generated by the braking system 5 decreases the rotation speed of the door 6 when the door 6 is opened.

The braking system 5 coupled to the door 6 is preferably positioned between the front wall 40 and the rear wall 42 of the refrigerating compartment door 24. In this embodiment, each lower corner of the opening 4 is provided with one braking system 5. In the description below, the braking system 5 positioned at the right lower corner of the opening 4 will be described. However, it should be noted that it is also possible that only one side of the door 6 is provided with the braking system 5.

The braking system 5 comprises a damper 10 to generate the damping force. In this embodiment, the damper 10 is arranged below and distanced from the lower edge 4a of the opening 4. The damper 10 is also positioned below and at a distance from the door 6 in a longitudinal direction.

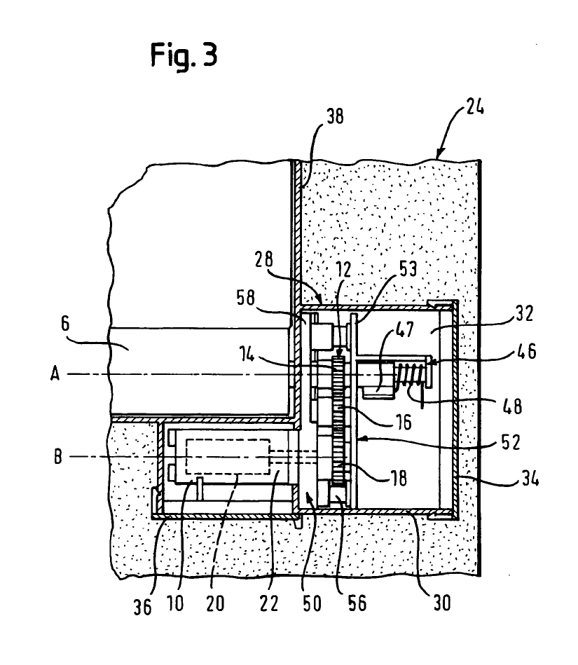

As shown in FIG. 3, the damper 10 has a chamber 22 and a rotatable element 20 inside of the chamber 22. The rotatable element 20 is configured to rotate about a second rotation axis B. The second rotation axis B is distanced from the first rotation axis A and parallel to the latter.

The chamber 22 is filled with viscous fluid (such as oil) which is in contact with the rotatable element 20, whereby when the rotatable element 20 rotates friction force is generated between the rotatable element 20 and the viscous fluid.

Referring to FIGS. 3 to 6 in combination with FIG. 1, the braking system 5 comprises a transmission unit 12. The transmission unit 12 is coupled between the door 6 and the damper 10. In particular, the input end of the transmission unit 12 is coupled to the hinge shaft 8, and the output end thereof is coupled to the rotatable element 20 of the damper 10.

When the door 6 is opened, the movement of the door 6 is transmitted to the transmission unit 12 by the hinge shaft 8. The transmission unit 12 then drives the rotatable element 20 to rotate. Meanwhile, the friction force is generated against the rotation movement of the rotation element 20 and is transmitted to the door 6 by the transmission unit 12. In such a way, the downward rotation movement of the door 6 is damped and sharp fall of the door 6 can be prevented. Hereinafter, the transmission unit 12 will be illuminated in more details.

The transmission unit 12, arranged between the front wall 40 and the rear wall 42 of the refrigerating compartment door 24, is located beside the opening 4, in the side portion 25 of the refrigerating compartment door 24. The output end of the transmission unit 12 extends downwardly beyond the lower edge 4a of the opening 4 to couple with the damper 10.

In this embodiment, the transmission unit 12 utilizes a gear transmission. The transmission unit 12 comprises a first gear 14 coupled to the hinge shaft 8. The first gear 14 has a gear shaft 14a with a bore (not shown) into which the hinge shaft 8 is inserted. When the hinge shaft 8 rotates, the first gear 14 is driven by the hinge shaft 8 to rotate about the first rotation axis A.

The transmission unit 12 further includes a second gear 18 coupled to the damper 10 to drive the rotatable element 20 of the damper 10. The second gear 18 is a cylinder gear in this embodiment, and rotatable about the second rotation axis B. The second gear 18 is located below the first gear 14.

In this embodiment, the transmission unit 12 further includes two transmission gears 15, 16 coupled in series between the first and second gears 14, 18. The transmission gear 15 coupled to the first gear 14 has a rotation axis that is parallel to the first rotation axis A. The transmission gear 15 is closer to the rear wall 42 than the first gear 14.

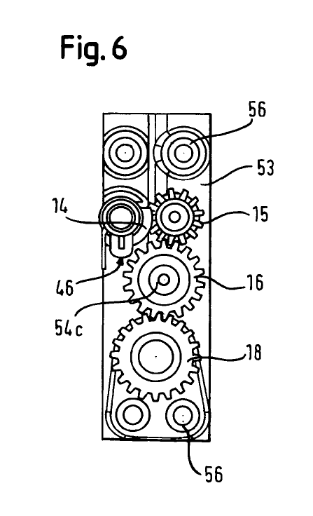

The rotation axis of the transmission gear 16 which is coupled between the transmission gear 15 and the second gear 18 is located lower than the first gear 14 and the transmission gear 15. The rotation axis of the transmission gear 16 is distanced from both of the first rotation axis A, the second rotation axis B as well as the rotation axis of the transmission gear 15 in the front-rear direction. As shown in FIG. 6, each of the rotation axes of the transmission gears 15, 16 is distanced from a plane defined by the first rotation axis A and the second rotation axis B.

The first gear 14 has a diameter less than the second gear 18. The transmission unit 12 has a transmission ratio less than 1 from the door 6 to the damper 10. In such a way, the damper 10 can be kept at a lower speed which is particularly advantageous when the damper 10 employs viscous fluid. Meanwhile, the damping force from the damper 10 can be amplified with such arrangement.

The braking system 5 includes a mounting base 50 for mounting the transmission unit 12. The mounting base 50 comprises a base plate 58 and a plurality of protrusions 54a, 54b, 54c, 54d projecting from the base plate 58. The gears 14, 15, 16, 18 are attached to the protrusions 54a, 54b, 54c, 54d by their gear shafts, respectively. The protrusions 54a, 54b, 54c, 54d each has an axis which is the same to the rotation axis of the gears 14, 15, 16, 18, respectively.

A cylindrical bore 55 is formed in the protrusion 54a and penetrating the base plate 58 to receive the hinge shaft 8. The hinge shaft 8 is then inserted into the bore of the gear shaft 14a of the first gear 14 for coupling with the first gear 14.

The mounting base 50 is preferably an integral member, for instance it can be made by insert molding process, which is particularly advantageous to control the distance between the protrusions 54a, 54b, 54c, 54d and accordingly the distance between the gears 14, 15, 16, 18 can be controlled more accurately.

The braking system has a cover 52 attached to the mounting base 50. The cover 52 has a cover plate 53 which is substantially parallel to the base plate 58.

The mounting base 50 comprises a plurality of connection portions 56 dependent from the base plate 58 and extending towards the cover 52. The connection portions 56 each has a bore with thread therein. The connection portions 56 extend in a direction parallel to the first rotation axis A. The cover 52 has a plurality of holes 57 formed through a cover plate 53 of the cover 52. Fixing means (not shown) for example screws are inserted through the holes 57 and into the bore of the connection portions 56, respectively, to fix the cover 52 to the mounting base 50. The gears 14, 15, 16, 18 are accordingly received between the base plate 58 and the cover plate 53.

To ensure the door 6 is able to reliably rotate to said predetermined angle after which the gravity of the door 6 is able to make the door 6 rotate downwardly when the door 6 is opened, a second door-opening unit 46 is preferably provided, in addition to the first door-opening unit 43, to generate a second opening force to the door 6 when the door 6 is in the close position. In such a way, when the door 6 is released from the locked state, the first and second opening force make the door 6 rotate at least to the predetermined angle after which the door 6 rotates because of the gravity thereof.

The second door-opening unit 46 is located lower than first door-opening unit 43 in a longitudinal direction when the door 6 is in the closed position. While the first door-opening unit 43 is located in association with the upper portion of the door 6, the second door-opening unit 46 is arranged closer to the first rotation axis than the first door-opening unit 43.

The second door-opening unit 46 is coupled to the hinge shaft 8, the second opening force accordingly acts on the hinge shaft 8 directly. In this embodiment, the second door-opening unit 46 includes a torsion spring 48. The torsion spring 48 may have an axis which is at least substantially parallel to the first rotation axis A when the torsion spring 48 is under a free state.

The cover 52 comprises a cavity 49 in which a cylinder 51 is extending towards the mounting base 50 along the first rotation axis A. The torsion spring 48 is attached to the cylinder 51 and a first end of the torsion spring 48 is coupled fixedly to the cover 52. The second end of the torsion spring 48 is coupled to the gear shaft 14a of the first gear 14.

In particular, the cavity 49 is opened at a side closer to the mounting base 50 to receive the hinge shaft 14a. The cylinder 51 has a front portion that is inserted into the bore of the hinge shaft 14a. The gear shaft 14a has a mounting projection 47 protruding from its outer surface. The mounting projection 47 has a receiving bore therein extending in a direction parallel to the first rotation axis A. The second end of the torsion spring 48 is received in the receiving bore of the mounting projection 47. In such a way, the second door-opening unit 46 is coupled to the first gear 14, the hinge shaft 8 and the braking system 5.

When the door 6 is maintained in the close position, the torsion spring 48 is twisted and thus has a potential energy because of torque. When the door 6 is released from the locked state by pushing the first door-opening unit 43, the torque of the torsion spring 48 and the first opening force generated by the first door-opening unit 43 drive the hinge shaft 8 to rotate, which makes the door 6 rotate outwardly.

In this embodiment, the potential energy of the torsion spring 48 is consumed when the door 6 reach its open position, i.e. the torsion spring 48 is under the free state when the door 6 is in the open position. Accordingly the second opening force is continuously acted on the door 6 when the door 6 rotates from the close position to the open position. However, the second opening force is decreased when the door 6 rotates from the close position to the open position, and the influence on rotation speed of the door 6 after the door 6 rotates because of its gravity can be ignored, because the second opening force is significantly smaller than the damping force generated by the braking system 5 and the gravity of the door 6.

As set forth above, the braking system 5 is arranged between the front and rear walls 40, 42 of the refrigerating compartment door 24. To prevent the thermal insulation material being contact with the transmission unit 12 and the damper 10, the transmission unit 12 and the damper 10 is enclosed in a casing 28 which insulates the braking system 5 from the thermal insulation material, as shown in FIG. 3.

Preferably, the casing 28 has a body 30 defining a receiving chamber 32 for receiving the transmission unit 12 and the damper 10. The receiving chamber 32 is disposed in the thermal insulation space of the refrigerating compartment door 24. The receiving chamber 32 is opened at one end thereof for allowing insertion of the transmission unit 12 and the damper 10. After the transmission unit 12 and the damper 10 are received in the receiving chamber 32, lids 34, 36 are attached to the body 30 to close the receiving chamber 32 such that the receiving chamber 32 is isolated from the thermal insulation material in the thermal insulation space.

The casing 28 is attached to the frame 38. This is advantageous to position the casing 28 when foaming the main door 24. The frame 38 has a first side exposed to the opening 4 and an opposite second side faced to the thermal insulation space. The casing 28 is attached to the frame 38 at the second side. The body 30 of the casing 28 is preferably made as an integral part of the frame 38 for instance by an insert molding process.

In particular, the casing 28 is positioned at a lower corner of the frame 38, with the receiving chamber 32 extending along the lower edge 4a and the side edge 4c.

In the embodiment as illustrated above, the braking system 5 is configured to damp the movement of the door 6 in the refrigerating compartment door (main door). However, the present invention should not be limited thereto. For instance, the present invention is also suitable for household appliance having a single door, such as dishwashers and ovens etc. The single door for such household appliance can also be damped according to the present invention, in particular when the door is rotatable about a horizontal axis.

1-29. (canceled)

30. A household appliance, comprising:
a housing having an opening;
a door rotatable about a first rotation axis to selectively open or close the opening; and
a braking system to damp a rotational movement of the door when the door is opened or closed, the braking system comprising:
a damper; and
a transmission unit coupled between the door and the damper to be driven by the door and for transmitting a movement of the door to the damper.

31. The household appliance of claim 30, wherein the door comprises a hinge shaft that defines the first rotation axis, and wherein the transmission unit is coupled to the hinge shaft.

32. The household appliance of claim 30, wherein the transmission unit has a transmission ratio of less than 1 from the door to the damper.

33. The household appliance of claim 30, wherein the damper comprises a rotatable element configured to rotate about a second rotation axis which is distanced from the first rotation axis.

34. The household appliance of claim 33, wherein the second rotation axis is parallel to the first rotation axis.

35. The household appliance of claim 33, wherein the damper comprises a chamber with viscous fluid that is in contact with the rotatable element.

36. The household appliance of claim 30, wherein the damper is arranged in the housing along a transversal edge of the opening.

37. The household appliance of claim 30, wherein the damper is positioned lower than the door in a longitudinal direction.

38. The household appliance of claim 30, wherein the transmission unit comprises at least two gears.

39. The household appliance of claim 38, wherein the at least two gears comprise a first gear rotatable about the first rotation axis and a second gear coupled to the damper.

40. The household appliance of claim 39, wherein the diameter of the second gear is larger than the diameter of the first gear.

41. The household appliance of claim 38, wherein the braking system comprises a mounting base to which the at least two gears are attached.

42. The household appliance of claim 39, wherein the transmission unit further comprises at least one further gear coupled between the first gear and the second gear.

43. The household appliance of claim 42, wherein a rotation axis of the further gear is distanced from a plane defined by the first and second rotation axes of the first and second gears.

44. The household appliance of claim 30, wherein the transmission unit comprises at least one of a belt transmission device and a chain transmission device.

45. The household appliance of claim 30, further comprising at least one opening unit to generate an opening force on the door at least when the door is closed, and wherein the opening unit is coupled to the braking system.

46. The household appliance of claim 45, wherein the opening unit comprises a spring.

47. The household appliance according to claim 46, wherein the spring is a torsion spring.

48. The household appliance of claim 30, wherein the housing comprises a storage compartment and a main door for selectively opening or closing the storage compartment; wherein the opening is formed through the main door; and wherein the door is attached to the main door.

49. The household appliance of claim 48, wherein at least part of the transmission unit is positioned in the main door.

50. The household appliance of claim 48, wherein the main door has a side wall and a side portion positioned between the side wall and an adjacent longitudinal edge of the opening, and wherein at least part of the transmission unit is located in the side portion.

51. The household appliance of claim 48, wherein the main door comprises a front wall and a rear wall which faces the storage compartment when the main door is closed, and wherein the damper and the transmission unit are disposed between the front wall and the rear wall.

52. The household appliance of claim 30, further comprising a casing enclosing at least one the transmission unit and the damper.

53. The household appliance of claim 52, wherein the casing comprises a body defining a receiving chamber that receives at least one of the transmission unit and the damper, and wherein the casing comprises a lid attached to the body to close the receiving chamber.

54. The household appliance of claim 52, wherein the casing is attached to a frame that is mounted to the housing around the opening.

55. The household appliance of claim 54, wherein at least part of the casing is integrated with the frame as one part.

56. The household appliance of claim 54, wherein the frame has a first side facing the opening and the second side opposite of the first side, and wherein the casing is attached to the frame at the second side.

57. The household appliance of claim 30, wherein the first rotation axis is horizontal.

58. The household appliance of claim 30, wherein the household appliance is a refrigerator.
